(19) United States
(12) Patent Application Publication
(10) Pub. No.: US 2023/0329335 A1
(43) Pub. Date: Oct. 19, 2023

(54) Aerosol Generation Device with Heat Dissipation Perforations

(71) Applicant: JT International SA, Geneva (CH)

(72) Inventors: Akira Yamaguchi, Geneva (CH); Takehiro Mitsutsuka, Geneva (CH)

(73) Assignee: JT International SA, Geneva (CH)

(21) Appl. No.: 18/027,965

(22) PCT Filed: Oct. 13, 2021
(86) PCT No.: PCT/EP2021/078345

§ 371 Date: Mar. 23, 2023

(30) Foreign Application Priority Data
Oct. 16, 2020 (EP) 20202390.9

(51) Int. Cl. A24F 40/40; A24F 40/60; A24F 40/51; F28F 13/00

(52) U.S. Cl. CPC A24F 40/40; A24F 40/60; A24F 40/51; F28F 13/003

(57) ABSTRACT

An aerosol generation device includes a cover with a heat dissipation portion including a plurality of perforations for heat dissipation. In a first aspect, an aerosol generation device includes a heating unit for heating an aerosol generation substrate for generating an aerosol, a device housing for accommodating the heating unit, the device housing including a heat dissipation portion provided on a portion of the device housing that forms part of the exterior surface of the device housing. The heat dissipation portion includes a plurality of perforations through which heat from the inside of the device housing, which is generated inside the main housing by heat radiation and heat conduction from the heating unit, can dissipate to the outside of the device housing, wherein each perforation of the plurality of perforations has an opening surface area so small that the perforation is not visible to the unassisted human eye.

### FIELD OF INVENTION

The invention relates to an aerosol generation device, in particular an aerosol generation device comprising a cover with heat dissipation portion comprising a plurality of perforations for heat dissipation.

### TECHNICAL BACKGROUND

Aerosol generation devices commonly found on the marked comprise an aerosol generation unit for generating an aerosol for consumption by a user of the aerosol generation device. The aerosol generation unit typically comprises a heating unit that generates an aerosol by applying heat to an aerosol generation substrate. While a part of the heat generated by the heating unit in the process of generating the aerosol is dissipated through the aerosol and the airflow that transports the aerosol to the user for inhalation, a substantial part of the generated heat is transmitted to the surroundings of the heating unit within the aerosol generation device and subsequently dissipated through the device housing of the aerosol generation device to the outside. As a consequence, the interior space of the aerosol generation device can become hot, and components accommodated within the aerosol generation device can be damaged. Furthermore, the outer surface of the aerosol generation device, in particular portions that are proximate the heating unit, can also become hot. As a consequence, the device housing may become too hot to comfortably hold or touch, and may cause injuries to the user.

To address the above issues, some aerosol generation devices provide a thermally insulating element such as thermally insulating sleeve or wrapper. The thermally insulating element commonly encloses or wraps around at least the heating unit and reduces the transfer rate of heat from the heating unit to the outer surface of the device housing to prevent the outer surface of the aerosol generation device from becoming too hot. However, the thermally insulating element increases the overall size of the aerosol generation device, and needs to conform to spatial requirements of the interior space of the aerosol generation device posed by a plurality of components of the aerosol generation device. This increases the manufacturing complexity and drives up manufacturing costs. Additionally, while the thermally insulating element addresses the problem of the outer surface becoming too hot, it does not address the problem of the interior space of the aerosol generation device from becoming hot. In fact, reducing the thermal transfer of heat from the heating unit to the outer surface of the device housing can further cause the interior space to become even hotter.

Therefore, there is a need for an aerosol generation device that prevents the interior space of the aerosol generation device from becoming too hot to prevent damage to the aerosol generation device and injuries to a user.

### SUMMARY OF THE INVENTION

Some, or all of the above objectives are achieved by the invention as defined by the features of the independent claims. Preferred embodiments of the invention are defined by the features of the dependent claims.

A 1^{st} aspect of the invention is an aerosol generation device comprising a heating unit for heating an aerosol generation substrate for generating an aerosol, a device housing for accommodating the heating unit, the device housing comprising a heat dissipation portion provided on a portion of the device housing that forms part of the exterior surface of the device housing. The heat dissipation portion comprises a plurality of perforations through which heat from the inside of the device housing, which is generated inside the main housing by heat radiation and heat conduction from the heating unit, can dissipate to the outside of the device housing, wherein each perforation of the plurality of perforations has an opening surface area so small that the perforation is not visible to the unassisted human eye.

It should be noted that heat generated inside the aerosol generation device by heat radiation and heat conduction inside the device housing refers to heat that is generated in areas and spaces within the aerosol generation device that are not in airflow communication with the heating unit. Specifically, these areas are not in airflow communication with one or more airflow channels that allow air from outside the aerosol generation device to flow into the aerosol generation unit to transport a generated aerosol through an air outlet such as mouthpiece to a user for inhalation.

Since this heat does not serve in generating an aerosol, such heat is lost heat. The 1^{st} aspect is advantageous because the heat dissipation portion allows the lost heat to be dissipated to the outside of the aerosol generation device to prevent the interior space of the aerosol generation space from becoming too hot. By rendering the plurality of perforations of the heat dissipation portion so small that they are not visible to the unassisted human eye, the risk of ingress of unwanted particles can be reduced while at the same time an aesthetic uniform appearance of the aerosol generation can be achieved.

According to a 2^{nd} aspect, in the preceding aspect, the device housing includes a main housing that accommodates the heating unit, and a cover element that is detachably attached or connected to the main housing. The cover element covers a portion of the main housing against the outside of the aerosol generation device to form part of the exterior surface of the aerosol generation device.

The 2^{nd} aspect is advantageous because a detachable cover element allows convenient access to the main housing for maintenance and repairs while protecting the covered portion of the main housing from outside influences.

According to a 3^{rd} aspect, in any one of the preceding aspects, the heat dissipation portion is provided on the cover element.

The 3^{rd} aspect is advantageous because it allows convenient access to the interior side of the heat dissipation portion for maintenance and repairs.

According to a 4^{th} aspect, in any one of the preceding aspects, a thermally conductive element is provided along the surface of a portion of the device housing that forms part of the exterior surface of the device housing.

The 4^{th} aspect is advantageous because the thermally conductive element allows heat to be distributed along its extension dimensions to provide a more uniform heat distribution of the device housing. This reduces the emergence of hot spots.

According to a 5^{th} aspect, in the preceding aspect and the 2^{nd} aspect, the thermally conductive element is provided along the inner surface of the cover element facing the main housing.

The 5^{th} aspect is advantageous because it provides a more uniform heat distribution of the cover element, while being protected by the cover element, to reduce the emergence of hot spots.

According to a 6^{th} aspect, in any one of in the 4^{th} aspect to the 5^{th} aspect, at least a portion of the thermally conductive element is arranged opposite of and facing at least portion of the heating unit.

According to a 7^{th} aspect, in any one of in the 4^{th} aspect to the 5^{th} aspect, at least a portion of the thermally conductive element is arranged opposite and facing a first portion of the main housing that does not form part of the exterior surface of the aerosol generation device, wherein substantially the entire surface of the first portion that faces the heating unit and faces away from the cover element is adjacent the heating unit.

The 6^{th} aspect and the 7^{th} aspect are advantageous because they respectively allow the lost heat from the heating unit to be distributed by the thermally conductive element to reduce the emergence of hot spots or hot regions.

According to an 8^{th} aspect, in any one of in the 4^{th} to aspects, the thermally conductive element is provided along at least a portion of or the entire inner surface of the heat dissipation portion.

The 8^{th} aspect is advantageous because it allows heat to be distributed towards the heat dissipation portion to increase the dissipation of heat by the heat dissipation portion.

According to a 9^{th} aspect, in the preceding aspect, a portion or all of the perforations of the plurality of perforations extend from the outside of the device housing through the thermally conductive element into the inside of the device housing.

The 9^{th} aspect is advantageous because it allows heat and hot air to be distributed towards the heat dissipation portion and through the perforations to increase the dissipation of heat by the heat dissipation portion.

According to a 10^{th} aspect, in any one of in the 4^{th} to 9^{th} aspects, the thermally conductive element is provided in contact with at least a portion of the interior surface of the heat dissipation portion.

The 10^{th} aspect is advantageous because it improves the distribution of heat from the thermally conductive element to the cover element along the extension directions of the thermally conductive element, and it increases the dissipation of heat from the thermally conductive element via the cover element to the outside of the aerosol generation device.

According to an 11^{th} aspect, in any one of in the 4^{th} to 10^{th} aspects, the thermally conductive element comprises a strip, plate, bar, or rod shape.

The 11^{th} aspect is advantageous because a strip, layer, rod, or bar are cost-efficient during manufacture, and the symmetry of the shapes of a strip, layer, rod, or bar provide a more uniform heating of the cover element to reduce the emergence of hot spots.

According to a 12^{th} aspect, in any one of in the 4^{th} to 11^{th} aspects, the thermally conductive element comprises a metal material.

According to a 13^{th} aspect, in the preceding aspect, the thermally conductive element comprises or substantially consists of copper.

The 12^{th} and 13^{th} aspects are advantageous because metal materials commonly possess excellent thermally conductive properties to provide excellent thermal distribution of heat. Copper in particular provides optimal thermally conductive properties and is cost-efficient.

According to a 14^{th} aspect, in any one of the preceding aspects, the aerosol generation device comprises a user operation portion that is provided on the exterior surface of the aerosol generation device and that can be actuated by a user for operating the aerosol generation device.

According to a 15^{th} aspect, in the preceding aspect, the user operation portion comprises one or more user input elements.

The 14^{th} and the 15^{th} aspects are advantageous because they respectively allow a user to reliably provide an input for operating the aerosol generation device.

According to a 16^{th} aspect, in the preceding aspect, the one or more user input elements comprise a button or a switch and actuating the button or the switch comprises pressing, touching, and/or contacting the button or the switch.

The 16^{th} aspect is advantageous because a button or switch can be cost-efficiently implemented to be reliably actuated by a simple action of a user.

According to a 17^{th} aspect, in any one of the 2^{nd} to 16^{th} aspects, the aerosol generation device comprises an operation interface portion that is provided at at least a portion of the surface of the main housing that is covered by the cover element and that can be actuated for operating the aerosol generation device.

According to an 18^{th} aspect, in the preceding aspect, actuating the operation interface portion comprises interacting, engaging, or contacting one or more operation input elements provided at the operation interface portion.

The 17^{th} and 18^{th} aspects are advantageous because they respectively allow a user to operate the aerosol generation device by inputting an operation. Furthermore, the cover element provides protection for the operation interface portion from outside influences.

According to a 19^{th} aspect, in the preceding aspect, the one or more input elements comprise a button, a switch, and/or a sensor.

The 19^{th} aspect is advantageous because a button, a switch, or a sensor allow an input operation to be reliably and repeatedly provided.

According to a 10^{th} aspect, in the preceding aspect, the sensor comprises a magnetic sensor or an optical sensor.

The 10^{th} aspect is advantageous because an optical or magnetic sensor can be actuated without being physically contacted and is thus subjected to less wear and tear from repeated use.

According to a 21^{st} aspect, in any one of in the 14^{th} to 16^{th} aspects, the user operation portion is provided with the cover element and forms part of the exterior surface of the cover element.

The 21^{st} aspect is advantageous because the detachable cover element provides convenient access to the user operation portion for maintenance or repairs.

According to a 22^{nd} aspect, in the preceding aspect and any one of in the 17^{th} to 10^{th} aspects, the user operation portion is configured to actuate the operation interface portion.

The 22^{nd} aspect is advantageous because it allows the operation interface portion to be actuated via the user operation portion without the operation interface portion being accessible to the outside while being covered by the cover element. This increases the durability of the operation interface portion.

According to a 23^{rd} aspect, in the preceding aspect, the user operation portion comprises a flexible region that can be elastically deformed towards the operation interface portion when pressed by user, wherein deforming the flexible region towards the operation interface portion actuates the operation interface portion.

The 23^{rd} aspect is advantageous because it allows the operation interface portion to be actuated via the user operation portion via simple mechanism. This increases the durability of the cover element.

According to a 24^{th} aspect, in any one of the 21^{st} to 23^{rd} aspects and in any one of the 5^{th} to 13^{th} aspects, the thermally conductive element is not provided along the interior surface of the portion of cover element formed by user operation portion.

The 24^{th} aspect is advantageous because it avoids heat to be distributed to the user operation portion by the thermally conductive element to protect the user operation portion from being damaged.

According to a 25^{th} aspect, in any of in the 2^{nd} to 24^{th} aspects, an output element is provided at the surface of the main housing between the main housing and the cover element.

According to a 26^{th} aspect, in the preceding aspect, the output element comprises a light emitting indicator.

The 25^{th} aspect and the 26^{th} aspect are advantageous because they respectively allow the aerosol generation device to provide output information such as feedback information to a user of the aerosol generation device.

According to a 27^{th} aspect, in the preceding aspect, the light emitting indicator is arranged inside the device housing to be opposite and face the interior surface of the heat dissipation portion.

The 27^{th} aspect is advantageous because it allows the light emitting indicator to be seen through the plurality of perforations of the heat dissipation portion while being covered and protected by the cover element.

According to a 28^{th} aspect, in the preceding aspect, light emitted by the light emitting indicator is visible to the unassisted human eye through the plurality of perforations.

According to a 29^{th} aspect, in any one of the 27^{th} to 28^{th} aspects, the light emitting indictor is not visible through the plurality of perforations when the light emitting indicator is not emitting light.

The 28^{th} and 29^{th} aspects are advantageous because they improve the visibility of feedback provided by the light emitting indicator under non-ideal lighting conditions when it is difficult to discern whether the light emitting indicator is emitting light or not.

According to a 30^{th} aspect, in any one of the preceding aspects, the aerosol generation device is provided with a battery and a battery vent cover.

The 30^{th} aspect is advantageous because a battery is cheap, replaceable, and/or rechargeable power supply for powering the aerosol generation device. The vent cover prevents ingress of unwanted substance into the battery vent.

According to a 31^{st} aspect, in the preceding aspect, wherein at last a portion of or the entire interior surface of the heat dissipation portion is opposite and faces the battery vent cover.

The 31^{st} aspect is advantageous because it allows a pressure built-up when a battery suffers catastrophic failure to dissipate from the battery vent through the plurality of perforations to the outside of the device to reduce the risk of damage to the aerosol generation device and injuries to a user.

According to a 32^{nd} aspect, in the 2^{nd} aspect and in any one of in the 3^{rd} to 31^{st} aspects, the cover element is detachably attached to the main housing via a magnet provided at the cover element or the main housing.

The 32 aspect is advantageous because a magnet is less susceptible to mechanical wear and tear due to the cover element repeatedly being attached and detached than mechanical attaching means.

According to a 33^{rd} aspect, in the preceding aspect and any one of in the 5^{th} to 13^{th} aspects, the main housing is provided with a magnet that exerts an attractive force onto the thermally conductive element.

The 33^{rd} aspect is advantageous because it provides a reliable magnetic coupling element to which the magnet can couple for attaching the cover element to the main housing, thus reducing the need for a separate magnetic coupling element.

According to a 34^{th} aspect, in any one of the preceding aspects, the average opening area per perforation of the plurality of perforations is between 0.0001 mm² and 0.004 mm², preferably between 0.0002 mm² and 0.0035 mm², most preferably between 0.0003 mm² and 0.003 mm.

The 34^{th} aspects is advantageous because these size ranges provide an optimal compromise between non-visibility of the perforations to the unassisted human eye, sufficient heat dissipation properties, and manufacturing complexity.

According to a 35^{th} aspect, in any one of the 2^{nd} to 34^{th} aspects, the aerosol generation device comprises a cover detection means for detecting whether the cover element is attached to the main housing.

The 35^{th} aspect is advantageous because it allows a determination of whether the cover element is properly attached to ensure safe operation and protection of the aerosol generation device.

According to a 36^{th} aspect, in the preceding aspect, the cover detection means comprises a button or switch that is actuated when the cover element is attached to the main housing.

The 36^{th} aspect is advantageous because a button or switch can be cost-efficiently implemented for reliably and repeatedly detecting attachment of the cover element.

According to a 37^{th} aspect, in any one of in the 35^{th} to 36^{th} aspects, the cover detection means comprises sensor circuitry.

According to a 38^{th} aspect, in the preceding aspect, wherein the sensor circuitry comprises a Hall sensor, an optical sensor, and/or an electrical sensor.

The 37^{th} and 38^{th} aspects are advantageous because sensors are less susceptible to mechanical wear and tear due to repeated attachment and detachment of the cover element as the actuation of a Hall sensor, an optical sensor, or an electrical sensor does not require a mechanical actuation of the sensor by, e.g., pressing onto the sensor or otherwise moving a part of the sensor.

According to a 39^{th} aspect, in any one of the 35^{th} to 38^{th} aspects, the aerosol generation device comprises circuitry for controlling the operation of the aerosol generation device based on information from the cover detection means, the information comprising information about a first state in which it is detected that the cover element is attached to the main housing and about a second state in which it is detected that the cover element is not attached to the main housing.

Proper positioning and attachment of the cover element are important for ensuring that a user may properly and safely operate the aerosol generation device. The 39^{th} aspect is therefore advantageous because it allows the operation of the aerosol generation device to be adapted based on whether the cover element is properly attached or not.

According to 40^{th} aspect, in the preceding aspect, controlling the operation of the aerosol generation device based on information from the cover detection means comprises preventing or inhibiting generation of an aerosol by the aerosol generation device if the information from the cover detecting means indicates the second state, and enabling generation of an aerosol by the aerosol generation device if the information from the cover detecting means indicates the first state.

If the cover element is not detected as attached, proper and safe operation of the aerosol generation device cannot be ensured. The 40^{th} aspect is therefore advantageous because it prevents unsafe operation of the aerosol generation device.

According to a 41^{st} aspect, in the preceding aspect, when the cover element is attached or connected to the main housing, the cover element and the main housing form the exterior surface of the aerosol generation device that is smooth and uniform except for seams that are formed where the cover element and the main housing are adjoined.

According to a 42^{nd} aspect, in any one of in the 2^{nd} to 41^{st} aspects, when the cover element is attached to the main housing, the exterior surface of the cover element makes up between 10% and 60% of the total exterior surface of the aerosol generation device.

According to a 43^{rd} aspect, in any one of the preceding aspects, the aerosol generation device is an electronic cigarette.

### BRIEF DESCRIPTION OF THE DRAWINGS

FIGS. 1A and 1B respectively show schematic illustrations of a side-view and a top-view of an aerosol generation device, according to embodiments of the invention;

FIGS. 2A and 2B respectively show schematic illustrations of a side-view and a top-view of an aerosol generation device with a heat dissipation portion, according to embodiments of the invention;

FIGS. 3A, 3B respectively show schematic illustrations of a side-view and a top-view of an aerosol generation device with a heat dissipation portion, FIG. 3C shows a schematic illustration of a bottom view of the cover element detached from the main housing by being rotated by 180° around the axis marked R, and FIG. 3D shows a schematic illustration of a top-view of the main housing from which the cover element shown in FIG. 3C has been detached, according to embodiments of the invention;

FIGS. 4A, 4B, 4C, and 4D respectively show partial cross-sectional side views of aerosol generation devices with a cover element, according to embodiments of the invention.

### DETAILED DESCRIPTION OF PREFERRED EMBODIMENTS

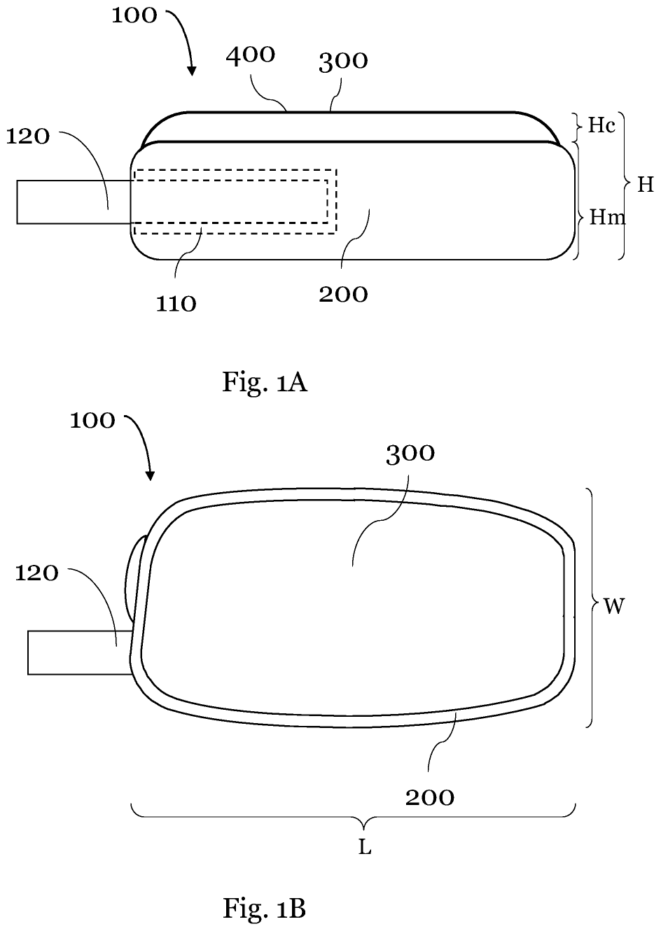

As shown in FIGS. 1A and 1B, the aerosol generation device 100 comprises a main housing 200 and a cover element 300. The main housing 200 is configured to accommodate an aerosol generation unit for generating an aerosol for consumption by a user. The aerosol generation unit comprises a heating unit 110 that is configured for heating a consumable 120 comprising an aerosol generation substrate. The aerosol generation device 100 also comprises a power supply that may be a replaceable and/or rechargeable power supply, and may additionally be provided with a charging port for charging the rechargeable power supply. The power supply may preferably be a battery that may be provided with a battery vent and a battery vent cover. The cover element 300 may be detachably attached to the main housing 200. The cover element being detachable means that the cover element 300 is detachable from the main housing by a user of the aerosol generation device 100 without requiring any additional tools or aids, but can be detached by the user utilizing one or both hands. As an alternative, the cover element may not be detachable and may be integrally formed with the main housing.

The aerosol generation device 100 may have an elongated shape to improve the comfort of a user when holding the aerosol generation device 100. The longitudinal direction of the aerosol generation device 100 is the direction, in which the aerosol generation device 100 is elongated. The extension of the aerosol generation device 100 in the longitudinal direction corresponds to the length L of the aerosol generation device 100, and the longitudinal direction of the aerosol generation device 100 corresponds to the length direction of the aerosol generation device 100. The aerosol generation device 100 has a transverse cross-section that lies in a transversal plane that is transverse to the longitudinal direction of the aerosol generation device 100. The transverse cross-section of the aerosol generation device 100 may in general be of any appropriate shape, but may preferably be of a rectangular, squared, circular, or elliptical shape. The longitudinal direction of the cross-section is a first transverse or radial direction of the aerosol generation device 100 and corresponds to the direction, in which the cross-section may be elongated. The extension of the cross-section in the first transverse or radial direction corresponds to the width W of the aerosol generation device 100, and the first transverse or radial direction of the aerosol generation device 100 corresponds to the width direction of the aerosol generation device 100. A direction perpendicular to the length direction and the width direction of the aerosol generation device 100 is a second transverse or radial direction of the aerosol generation device 100. The extension of the cross-section in the second transverse or radial direction corresponds to the height H of the aerosol generation device 100, and the second transverse or radial direction corresponds to the height direction of the aerosol generation device 100. In case of a circular cross-section, the width direction and height direction may be chosen at will as long as they are perpendicular to each other. In case of a squared cross-section, the width direction corresponds to the direct distance direction between two opposing sides of the square, and the height direction corresponds to the direction perpendicular to the width direction in the plane of the cross-section.

As shown in FIG. 1A, the cover element 300 is attached to the main housing 200 of the aerosol generation device 100 preferably from the height direction of the aerosol generation device 100, i.e., when attached to the main housing 200 of the aerosol generation device 100, the cover element 300 increases the height H of the aerosol generation device 100, but does not increase the length L and width W of the aerosol generation device 100, as show in FIG. 1B. The height H of the aerosol generation device 100 consists of the height Hc of the cover element 300 and the height Hm of the main housing 200, wherein the height Hc of the cover element 300 corresponds to difference between the height H of the aerosol generation device 100 and the height Hm of the main housing 200. Preferably, the height Hc of cover element 300 is less than 30% of the height H of the aerosol generation device 100. This ensures that, when the cover element 300 is attached, the overall size of the aerosol generation device 100 is such that the aerosol generation device 100 can be comfortably used and held by a user using a single hand. When the cover element 300 is attached to the main housing, the exterior surface of the cover element 300 is the surface of the cover element 300 that is opposite the inner surface of the cover element 300 that is the surface that faces the main housing 200. The exterior surface of the cover element 300 may preferably make up between 10% and 60% of the total exterior surface of the aerosol generation device. When the cover element 300 is attached to the main housing 200, the exterior surface of the aerosol generation device 100 may be a smooth and uniform surface except for seams that are formed where the cover element 300 and the main housing 200 are adjoined. In particular, the exterior surface of the cover element 300 has a smooth and continuous shape, and the transition from the exterior surface of the cover element 300 to the exterior surface of the main housing 200 is smooth and continuous with the exception of a seam that is formed at the transition. It should be noted that the aerosol generation device may comprise only a main housing without a cover element that can be detachably attached to the main housing.

The aerosol generation device 100 may be an electronic cigarette and may be configured to generate an aerosol from an e-vapor or t-vapor aerosol generation substrate. For example, the heating unit 110 may comprise a receptacle configured for receiving a tobacco stick or similar consumable 120, and a heating element may be configured for heating the receptable and the tobacco stick received in the receptacle. Alternatively, the receptable may be configured for receiving a cartridge containing an aerosol generation substrate such as a liquid, and the heating unit 110 may comprise a wicking element and a heating element configured for heating the wicking element. Depending on the aerosol generation substrate, the heating unit may heat the aerosol generation substrate to temperatures up to 350° C. for generating an aerosol. The aerosol generation device comprises an airflow path that extends from an air inlet via the aerosol generation unit to an air outlet. When a user consumes a consumable by inhaling a generated aerosol, air enters the air inlet, passes to the aerosol generation unit where an aerosol is generated by the heating unit by heating the aerosol generation substrate, and transports the generated aerosol the air outlet such as a mouthpiece. While the airflow path is in communication with the aerosol generation unit, the airflow path is typically not in communication with the remaining interior space of the aerosol generation. A portion of the heat generated by the heating unit 110 is transferred to the aerosol generation substrate for generating an aerosol and to the flow of air that transports the generated aerosol to a user for inhalation. However, a remaining and substantial portion of the generated heat is transferred to the interior space of the aerosol generation device that is not in communication with the airflow path and the aerosol generation unit. This substantial portion of the generated heat is subsequently dissipated over time through heat conduction and heat radiation to the outer surface of the aerosol generation device and subsequently to the ambient air. Since this heat does not serve to heat the aerosol generation substrate, this heat corresponds to lost heat that is lost to the interior space of the aerosol generation device in surrounding of the heating unit 110 that is not in communication with the heating unit 110.

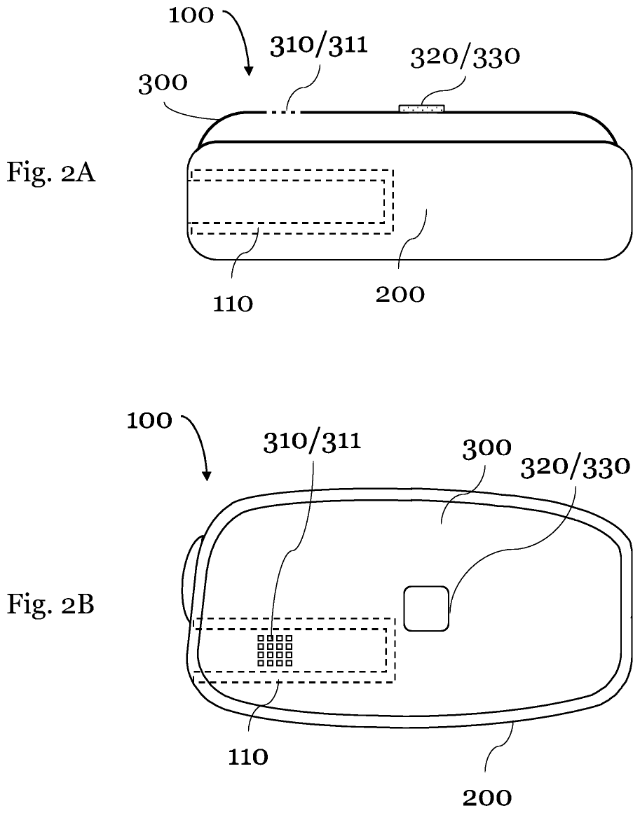

As shown in FIGS. 2A and 2B, a heat dissipation portion 310 comprising a plurality of perforations 311 is provided at the cover element 300 to form part of the exterior and part of interior surface of the cover element 300. In case the aerosol generation device 100 comprises only a main housing 200 without a cover element 300, the heat dissipation portion 310 is provided at the main housing 200 and forms part of the exterior and the interior surface of the main housing 200. A user operation portion 320 that comprises one or more user input elements 330 may be provided at the exterior surface of the cover element 300 to allow a user to provide an operation input to the aerosol generation device 100. The one or more user input elements may comprise a mechanical or capacitive button or a switch, and actuating the button or the switch may comprise pressing, touching, and/or contacting the button or the switch. The cover element 300 and the main housing 200 are shaped such that an air gap is arranged or preferably enclosed between the cover element 300 and the main housing 200. The air gap decreases the rate of heat transfer of the lost heat from the main housing through the air gap to the cover element 300. By decreasing the rate of heat dissipation, the maximum temperature to which outer surface of the cover element 300 is heated due to dissipation of the lost heat is reduced. As a consequence, the outer surface of the cover element 300 is prevented from becoming too hot to touch or hold by the user, and injuries to the user can be prevented. However, as result, due to the reduced heat dissipation rate, the interior space of the main housing 200 can become hotter. This can lead to damage to the aerosol generation device and injuries to the user.

To address this problem, the heat dissipation portion 310 comprises a plurality of perforations 311. Heat and hot air can dissipate from the air gap through the plurality of perforations 311 to the outside of the aerosol generation device 100. As a consequence, the heat dissipation rate from the heating unit 110 to the outside of the aerosol generation device can be increased without increasing the heat dissipation rate via the exterior surface of the cover element 300. Additionally, or alternatively, a heat dissipation portion 310 may be provided at a portion of the main housing 200 that forms part of the exterior surface of the aerosol generation device 100. When provided on the cover element 300, the heat dissipation portion 310 is preferably arranged such that its inner surface is opposite of and faces a portion of the main housing 200 that is entirely adjacent the heating unit 110. This way, the heat dissipation portion provided on the cover element 300 is arranged in closest proximity to the heating unit 110 and increases the heat dissipation rate with which lost heat from the heating unit 110 is dissipated through the plurality of perforations 311 of the heat dissipation portion 310 to the outside of the aerosol generation device 100. The plurality of perforations 311 is configured such that each perforation of the plurality of perforations 311 is not visible to the unassisted human eye. This can be achieved by reducing the size of the opening area of each perforation such that the perforation becomes not visible to the unassisted human eye. This effect can be achieved with perforations that have an average opening area between 0.0001 mm² and 0.004 mm², preferably between 0.0002 mm² and 0.0035 mm², most preferably between 0.0003 mm² and 0.003 mm². In addition to providing a pleasing aesthetic appearance by rendering the perforations not visible to the unassisted human eye, such a small opening area prevents ingress of particles larger than the opening area. It should be noted that non-visibility of the plurality of perforations means non-visibility under normal viewing conditions. If a cover element 300 is provided, the cover element 300 is attached or connected to the main housing 200 under the normal viewing conditions. Under normal viewing conditions, the micro-perforations are viewed by a user of the aerosol generation device under common ambient light conditions and without any illumination provided inside the device housing of the aerosol generation device. Under normal viewing conditions, the micro-perforations are viewed from a normal viewing distance that ranges from a largest normal viewing distance that is a typical distance between a user's eye and the hand on an outstretched arm, to a smallest normal viewing distance that corresponds to the near point of a human eye. The near point is typically defined to be 25 cm.

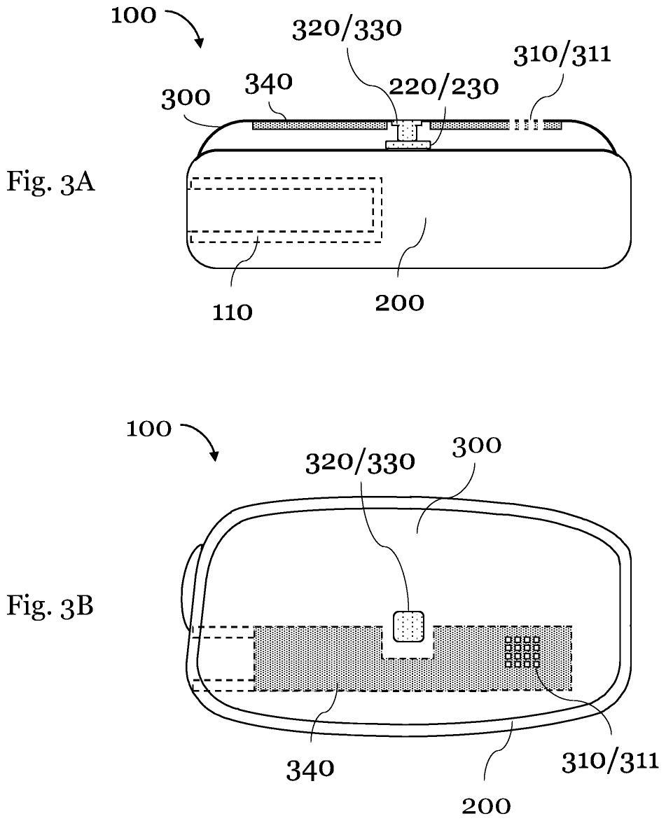

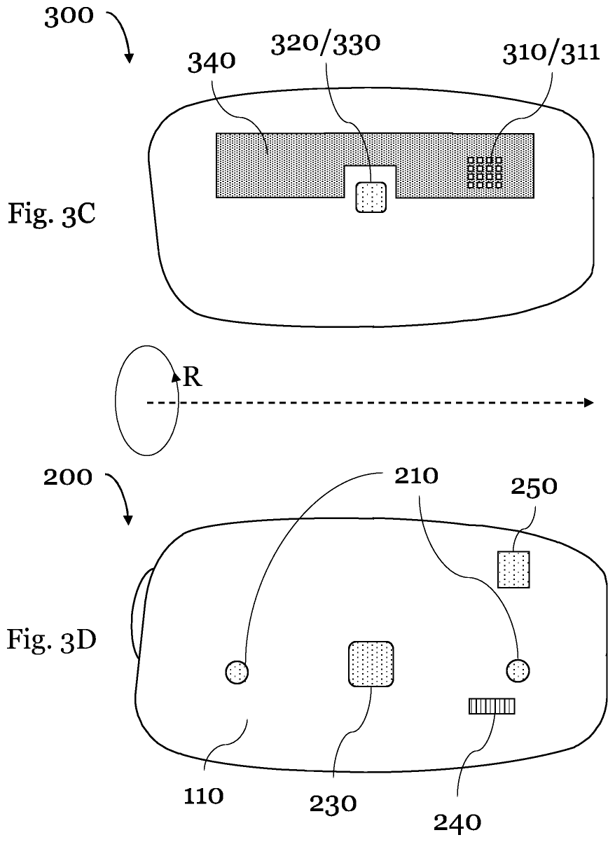

As shown in FIGS. 3A and 3B, the heat dissipation portion 310 may be provided at a portion of the cover element 300 that is positioned such that the inner surface of the heat dissipation portion 310 is not opposite of and does not face a portion of the main housing 200 that is entirely adjacent the heating unit 110. In order to improve heat dissipation from the heating unit 110 through the heat dissipation portion 310 in such a configuration, a thermally conductive element 340 may be provided along a portion or all of the inner surface of the cover element 300. The thermally conductive element 340 comprises a first portion that is arranged such that it is opposite of and face a portion of the main housing 200 that is entirely adjacent the heating unit 110. The thermally conductive element 340 preferably extends to the heat dissipation portion 310 by comprising a second portion different from the first portion, the second portion being arranged on at least a portion of the inner surface of the heat dissipation portion 310.

This way, the thermally conductive element 340 can conduct heat towards the heat dissipation portion 310. In case the aerosol generation device 100 is provided with a main housing 200 without a cover element 300, the thermally conductive element 340 may be provided on the inner surface of the main housing 200 and extend from a portion of the inner surface of the main housing 200 adjacent the heating unit 110 towards the inner surface of the heat dissipation portion 310. Preferably, the thermally conductive element 340 is sized such that it is provided along, preferably on at least a portion of or the entire inner surface of heat dissipation portion 310 to increase the heat dissipation rate through the heat dissipation portion 310. The thermally conductive element 340 may be configured to cover perforations of the plurality of perforations 311 of the heat dissipation portion when provided along or on at least a portion of or the entire inner surface of the heat dissipation portion 310. Alternatively, perforations of the plurality of perforations 311 may extend through the thermally conductive element 340 from the outside to the inside of the aerosol generation device 100. The thermally conductive element 340 may comprise or substantially consist of a metal material, preferably copper, as these materials typically possess excellent thermally conductive properties. The thermally conductive element 340 may comprise a strip, a plate, a bar, or a rod shape, or any combination thereof. These shapes possess geometric symmetries that allow a uniform heat distribution of the thermally conductive element. Furthermore, the thermally conductive element may comprise one or more of the above shapes to conform to different spatial and geometric requirements. In particular, the thermally conductive element 340 may be shaped such that it is not provided adjacent, along, and on the inner surface of an user operation portion 320 provided at a portion of the cover element 300 or the main housing 200 that forms part of the exterior surface of the aerosol generation device but circumvents it. This prevents heat to be distributed by the thermally conductive element 340 to the user operation portion 320 and prevents it from being damaged or becoming too hot for a user to touch. The thermally conductive element 340 is preferably a standalone element that may be attached or connected to the cover element 300, or the main housing 200 if the aerosol generation device 100 does not comprise a cover element 300, using any suitable technique known in the art.

In case a cover element 300 is provided, an operation interface portion 220 may be provided at a portion of the main housing 200 that is covered by the cover element 300. The operation interface portion 220 is protected from outside influences by the cover element 300, and like the user operation portion 320, can be actuated by a user for providing an operation input to the aerosol generation device 100. The operation interface portion 220 comprises one or more operation input elements 230 such as a mechanical or capacitive touch button or switch, an optical sensor, or a magnetic sensor. In a preferred configuration shown in FIG. 3A, the user operation portion 320 and the operation interface portion 220 may be configured such that actuating the user operation portion 320 actuates the operation interface portion 220 for providing an operation input to the aerosol generation device 100. In this case, actuating the user operation portion 320 alone may not provide any operation input to the aerosol generation device 100. Rather, the resulting actuation of the operation interface portion 220 caused by the actuation of the user operation portion 320 results in an operation input. For example, the user operation portion 320 may comprise a mechanical button or switch 330 that can be pressed or moved by a user. The mechanical button or switch 330 actuates an operation input element 230 of the operation interface portion 220 by having a protrusion or similar arrangement protruding towards the operation input element of the operation interface portion 220 such as a button or switch 230. When the button or switch 330 of the user operation area 320 is pressed, the protrusion causes the button or switch 220 of the operation interface portion 220 to be pressed. Additionally, or alternatively, the user operation portion 320 may be provided with a magnetic detection object such as a magnet or ferromagnetic object, or an optical detection object such as reflective surface, that can respectively actuate a magnetic sensor, or an optical sensor provided as an operation input element 230 of the operation interface portion 220 when the button or switch 330 is actuated. Alternatively, instead of a mechanical button or switch, the user operation portion 320 may comprise a flexible area that can be flexibly deformed towards the operation interface portion 220 when pressed by a user to actuate an operation input element 230 of the operation interface portion 220. Such configurations allow a user to actuate the operation interface portion 220 for providing an operation input to aerosol generation device 100 from outside the aerosol generation device by actuating the user operation area 320 without directly accessing or exposing the operation interface portion 220 covered by the cover element 300.

The cover element 300 may preferably be shaped as a panel. The cover element 300 may be substantially plate-shaped wherein the average thickness of the cover element 300 is less than 30% of the height Hc of the cover element 300 as described for embodiments in the context of FIG. 1A. The cover element 300 may preferably have a central portion that is substantially planar, and one or more peripheral or circumferential portions that are curved or bent to allow the cover element 300 to be adjoined to the main housing 200. Alternatively, the cover element 300 may have a continuously curved shape with a central portion having a curvature that is smaller than the curvature of one or more peripheral or circumferential portions. It should be noted that the cover element 300 and the main housing 200 may be formed of a same material, or the cover element 300 may be formed of a different material than the main housing 200. The cover element may be formed of or comprise a material that provides thermal insulating properties. The cover element 330 may comprise or be made from plastic materials such as polyethylene, polypropylene, polystyrene, ABS resin, methacrylate resin, and polyvinyl chloride. The cover element 300 reduces heat up of the exterior surface of the aerosol generation device 100 by the lost heat from the heating unit 110 to prevent a user from being injured by the heat. For this purpose, the cover element 300 may be provided with, comprise, or substantially consist of one or more layers of aerogel sheets, thermal insulating sheets, and foamed sheets, preferably foamed resin sheets, and/or foamed plastic.

As shown in FIG. 3C illustrating the inner surface of the cover element 300 that is detached from the main housing 200 illustrated in FIG. 3D by a rotation of 180° around a rotation axis R, the main housing 200 may be provided with attaching means 210 for detachably attaching the cover element 300 to the main housing 200. The attaching means 210 may comprise means such as a press-fit connection, clamping connection or similar connection. Additionally, or alternatively, the attaching means 210 may comprise magnetic means. The main housing 200 may be provided with a magnetic coupling element 210, and the cover element 300 may be provided with a magnetic counter-coupling element, wherein the coupling element and the counter-coupling element comprise a magnet and a ferromagnetic element. In a preferred configuration, the main housing 200 is provided with one or more magnets 210, and the thermally conductive element 340 comprises or substantially consists of a magnetic material. The one or more magnets are configured to exert an attractive magnetic force onto the thermally conductive element for attaching the cover element 300 to the main housing 200. The aerosol generation device 100 may further be provided with an operation output element 240. The operation output element 240 may comprise a light emitting indicator such as one or more LED light sources or an LED light strip. The light emitting indicator may indicate information indicating to an operational state to a user of the aerosol generation device 100, the information comprising, but not limited to information relating to an on/off state of the aerosol generation device 100, information relating a heating temperature of the aerosol generation device 100, information relating to a consumable in use with the aerosol generation device boo, information relating to a state of the power source of the aerosol generation device 100.

The light emitting indicator 240 may preferably be arranged to be opposite of and face the inner surface of the heat dissipation portion 310 with a plurality of perforations 311. Due to the small size, perforations of the plurality of perforation 311 are not visible to the unassisted eye. As a consequence, the light emitting indicator 240 is rendered not visible to the outside of the aerosol generation device 100 through perforations of the plurality of perforations 311 of the heat dissipation portion 310 when the light emitting indicator 240 is not emitting light, and becomes visible through the perforations 311 when the light emitting indicator is emitting light. In case the aerosol generation device 100 is provided with a battery with a battery vent for venting the battery in case of catastrophic failure, the battery vent is configured for venting the battery into the air gap arranged between the main housing 200 and the cover element 300, and the battery vent cover is provided at a portion of the surface of the main housing 200 that is covered by the cover element 300. In this case, the plurality of perforations 311 of the heat dissipation portion 310 provided at the cover element may function as pressure relief perforations. Any pressure built up in case of catastrophic battery failure can be vented through the battery vent into the air gap arranged between the main housing 200 and the cover element 300, and can subsequently be relieved to the outside of the aerosol generation device 100 through the plurality of perforations 311. This can prevent that an unrelieved pressure is built up in case of battery failure, and can prevent damage to the aerosol generation device and injuries to a user. To improve the venting performance of the plurality of perforations 311, the heat dissipation portion may preferably be arranged to be opposite of and face at least a portion of the battery vent cover to increase the rate of pressure relief from the battery vent through the plurality of perforations.

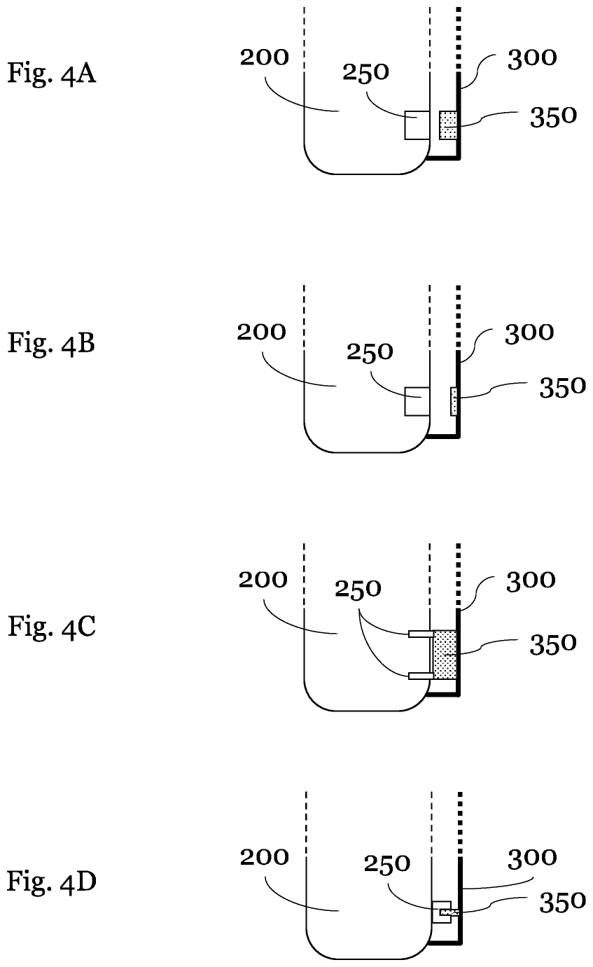

As shown in FIGS. 4A to 4D, the aerosol generation device 100 may be provided with a cover detection means 250 that is configured for detecting whether the cover element 300 is properly and securely attached to the main housing 200. The cover element 300 may be provided with a detection object 350 that is configured to be detected by the cover detection means 250 when the cover element 300 is attached to the main housing 200. The aerosol generation device 100 may further be provided with circuitry for controlling the operation of the aerosol generation device 100. The circuitry may be configured to control the operation of the aerosol generation device 100 based on information provided by the cover detection means 250. The information from the cover detection means 250 comprises information about a first state in which it is detected that the cover element 300 is attached to the main housing 200, and about a second state in which it is detected that the cover element 300 is not attached to the main housing 200. To ensure safe operation of the aerosol generation device 100, the circuitry may be configured to prevent or inhibit generation of an aerosol by the aerosol generation device 100. This may for example be achieved by preventing operation of a heating unit 110 for heating an aerosol generation substrate and/or by limiting operation of the heating unit 110 to a limited time duration or a limited temperature range. As shown in FIG. 4A, the cover detection means 250 may comprise a magnetic sensor such as a Hall sensor, and the cover element 300 may be provided with a magnetic detection object 350 such as ferromagnetic object that can be detected when the cover element 300 is attached to the main housing 200. The detection object 350 may be a dedicated object such as the thermally conductive element 340. Additionally, or alternatively, the cover element 300 may comprise or substantially consist of a ferromagnetic material that can be detected by the magnetic sensor. A first state in which the cover element 300 is properly and securely attached to the aerosol generation device 100 may be indicated when a detection signal generated in the magnetic sensor based on a distance between the magnetic sensor and the magnetic detection object is above a predetermined detection signal strength threshold, and a second state in which the cover element 300 is not properly and securely attached is indicated when the detection signal strength is below the predetermined threshold. Alternatively, the first state may be indicated when a detection signal is generated, and a second state is indicated when no detection signal strength is indicated. Additionally, or alternatively, as shown in FIG. 4B, the cover detection means 250 may comprise an optical sensor, and the cover element 300 may be provided with an optical detection object 350 such as a light reflective object that reflects light. The optical sensor may be an IR sensor that emits IR light. A first state may be indicated when the IR light emitted by the IR sensor is reflected back to the IR sensor to be detected by the IR sensor by the light reflective object when the cover element 300 is properly and securely attached to the main housing 200. A first state may additionally, or alternatively, be indicated when the reflected IR light that is detected by the IR sensor is above a predetermined intensity or coherence threshold. A second state may be indicated when the IR light emitted by the IR sensor is not reflected by the light reflective object 320 when the cover element 300 is not properly or securely attached to the main housing 200. A second state may additionally, or alternatively, be indicated when a reflected IR light that is detected by the IR sensor is below a predetermined intensity or coherence threshold. Additionally, or alternatively, as shown in FIG. 4C, the cover detection means may comprise an electrical sensor, and the cover element 300 may be provided with an electrical detection object. For example, the cover detection means may comprise an open electrical circuit with a plurality of electrical contacts that are exposed at the main housing 200 towards the cover element 300, and the cover element 300 may be provided with an electrically conductive element 320. A first state may be indicated when the plurality of contacts of the open electrical circuit are in contact with the electrically conductive element 320 of the cover element such that the open circuit is closed, and consequently a current flow or voltage drop can be detected. A first state may additionally, or alternatively be indicated, when the electrical detection object 350 has a resistance with a predetermined value or within a predetermined value range, and consequently the detected current or voltage drop has a predetermined value or is within a predetermined value range. As shown in FIG. 4D, the cover detection means 250 may additionally, or alternatively, comprise a button or switch, and the cover element 300 may be provided with detection object 350 such as a protrusion or similar structure for actuating the button or switch. The button or switch may be a mechanical and/or a capacitive touch button or switch. A first state may be indicated when the button or switch is actuated when the cover element 300 is properly and securely attached to the main housing, and a second state may be indicated when the button or switch is not actuated.

It should be noted that that cover detection means 250 may also function as an attaching means 210 for attaching the cover element 300 to the main housing 200. For example, the cover detection means 250 may comprise a magnetic sensor that exerts an attractive force onto a cover element 300 that comprises or is provided with a magnetic element. As another example, the cover detection means 250 may comprises a button or switch, and the cover element 300 may be mechanically attached or linked to the button or switch to attach the cover element 300 to the main housing 200. The mechanical attachment or linkage may be achieved via a mechanical press-fit connection or similar clamping or engaging configuration. As yet another example, the cover detection means 250 may comprise a plurality of electrical connecting elements such as pogo pins or pogo pin receptacles, and the cover element 300 may be provided with an electrically conductive element such as one or more pogo pins or pogo pin receptacles that engage with the electrical connecting elements of the cover detection means 250 to form a stable mechanical connections for attaching the cover element 300 to the main housing 200. Furthermore, the aerosol generation device may be provided with a plurality of heat dissipation portions 310 with a plurality of perforations 311 that may be provided on different portions of the aerosol generation device. For example, a first heat dissipation portion 310 may be provided at the cover element 300 that is arranged to be opposite and face a light emitting indicator. A second heat dissipation portion 310 may be provided to be opposite and face a portion of the main housing 200 covered by the cover element 300 and adjacent the heating unit. A third heat dissipation portion 310 may be provided to serve as a pressure relief portion for a battery vent. The aerosol generation device may be provided with any combination of one or more of the first, second, and third heat dissipation portion.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure, as defined by the independent and dependent claims.

### LIST OF REFERENCE SIGNS USED

100 aerosol generation device
110 heating unit
120 consumable
200 main housing
210 attaching means
220 operation interface portion
230 operation input element
240 output element
250 cover detection means
320 detection object
300 cover element
310 heat dissipation portion
311 heat dissipation perforation
320 user operation portion
330 user input element
340 thermally conductive element
350 cover detection object
H height of the aerosol generation device
L length of the aerosol generation device
W width of the aerosol generation device
Hm height of the main housing
Hc height of the cover element

1. An aerosol generation device comprising:
a heating unit for heating an aerosol generation substrate for generating an aerosol;
a device housing for accommodating the heating unit, the device housing comprising a heat dissipation portion provided on a portion of the device housing that forms part of an exterior surface of the device housing,
wherein the heat dissipation portion comprises a plurality of perforations through which heat from an inside of the device housing, which is generated inside a main housing of the device housing by heat radiation and heat conduction from the heating unit, is configured to dissipate to an outside of the device housing, and
wherein each perforation of the plurality of perforations has an opening surface area so small that the perforation is not visible to an unassisted human eye.

2. The aerosol generation device according to claim 1,
wherein the device housing includes:
the main housing that accommodates the heating unit; and
a cover element that is detachably attached or connected to the main housing that covers a portion of the main housing against an outside of the aerosol generation device to form part of an exterior surface of the aerosol generation device,
wherein the heat dissipation portion is provided on the cover element.

3. The aerosol generation device according to claim 2, wherein a thermally conductive element is provided along an inner surface of the cover element facing the main housing.

4. The aerosol generation device according to claim 3, wherein the thermally conductive element is provided along at least a portion of or an entire inner surface of the heat dissipation portion.

5. The aerosol generation device according to claim 4, wherein a portion or all of the perforations of the plurality of perforations extend from the outside of the device housing through the thermally conductive element into the inside of the device housing.

6. The aerosol generation device according to claim 3, wherein the thermally conductive element is provided in contact with at least a portion of an interior surface of the heat dissipation portion.

7. The aerosol generation device according to claim 3, wherein the thermally conductive element comprises a strip, plate, bar, or rod shape.

8. The aerosol generation device according to claim 2, further comprising a user operation portion that is provided on the exterior surface of the aerosol generation device and that is configured to be actuated by a user for operating the aerosol generation device, wherein the user operation portion comprises one or more user input elements.

9. The aerosol generation device according to claim 8, comprising an operation interface portion that is provided at at least a portion of a surface of the main housing that is covered by the cover element and that is configured to be actuated for operating the aerosol generation device.

10. The aerosol generation device according to claim 8, wherein the user operation portion is provided with the cover element and forms part of an exterior surface of the cover element.

11. The aerosol generation device according to claim 9, wherein the user operation portion is configured to actuate the operation interface portion.

12. The aerosol generation device according to claim 3, further comprising a user operation portion that is provided on the exterior surface of the aerosol generation device and that is configured to be actuated by a user for operating the aerosol generation device, wherein the user operation portion comprises one or more user input elements, wherein the user operation portion is provided with the cover element and forms part of an exterior surface of the cover element, and wherein the thermally conductive element is not provided along the inner surface of the portion of cover element formed by user operation portion.

13. The aerosol generation device according to claim 2, wherein an output element is disposed at a surface of the main housing between the main housing and the cover element,
wherein the output element comprises light emitting indicator,
wherein the light emitting indicator is disposed inside the device housing to be opposite and face an interior surface of the heat dissipation portion,
wherein light emitted by the light emitting indicator is visible to the unassisted human eye through the plurality of perforations, and
wherein the light emitting indictor is not visible through the plurality of perforations when the light emitting indicator is not emitting light.

14. The aerosol generation device according to claim 1, wherein an average opening surface area per perforation of the plurality of perforations is between 0.0001 mm² and 0.004 mm².

15. The aerosol generation device according to claim 2, further comprising a cover detection means for detecting whether the cover element is attached to the main housing.

16. The aerosol generation device according to claim 1, wherein an average opening surface area per perforation of the plurality of perforations is between 0.0002 mm² and 0.0035 mm².

17. The aerosol generation device according to claim 1, wherein an average opening surface area per perforation of the plurality of perforations is between 0.0003 mm² and 0.003 mm².
